(19) United States
(12) Patent Application Publication
(10) Pub. No.: US 2002/0117555 A1
(43) Pub. Date: Aug. 29, 2002

(54) Fountain device with a rotating revolver

(76) Inventor: Chung-Kuei Lin, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/794,498

(22) Filed: Feb. 28, 2001

(51) Int. Cl. B05B 17/08

(52) U.S. Cl. 239/17; 239/222.11; 239/382; 239/237; 239/204; 239/263

(57) ABSTRACT

A fountain device with rotating screen consists of a reservoir, a water supply system, a cover, and a top revolver. A bearing is secured in a blade chamber on the cover and can be rotated by hydraulic power to drive the top revolver. The top revolver is pivotally mounted on the bearing and can be changed easily, whereby the rotating screens of the fountain device can be changed easily to provide interest to consumers.

### BACKGROUND OF THE INVENTION

1. Field of the Invention

The present invention relates to a fountain device with a rotating revolver especially a fountain device wherein different top revolvers can be easily changed to make the fountain have a lot of variations to stimulate consumers.

2. Description of Related Art

A fountain is ordinarily constructed in the garden as an attractive part of beautiful scenery, but recently small indoor fountain sets have become popular, especially in artificial landscapes. A conventional fountain as used in a garden merely uses a water pump to ejaculate water from a nozzle continuously, and then the water spurting out may be formed as a water curtain. In order to make the fountain have additional novelty, some manufacturers have invented rotating fountains controlled by electricity.

The electrically controlled fountain, as shown in FIGS. 5 and 6, is composed of a water supply device (50), a fountain base (60), a water screen circulating and alternating mechanism (70) and at least one or more nozzle (80).

The detailed inner structure of the electronically controlled fountain is shown in Fig. 6. The water supply device (50) contains a spurt water stand (52), a reservoir and a water pump (54), and the fountain base (60) has a water inlet connected to the water pump (54) and a plurality of water holes, which be installed on the water supply device (50). The water screen circulating and alternating mechanism (70) is composed of a rotary shaft (72) in which a water diversion hole (74) is defined, and an eccentric and trumpet-like water diversion outlet (76). A drive wheel (58) has a plurality of radial plates and a drive worm connects with a shaft (581) of the drive wheel (58) and engages with a worm gear (59) installed at a periphery of the rotary shaft (72). Furthermore, each nozzle (80) further has a plurality of nozzle inlets which connects to the water holes of the fountain base (60), and water is fed to each nozzle and the radial plates. The drive wheel (58) can be rotated by hydraulic power to drive the rotary shaft (72), and thus the trumpet water diversion outlet (76) can aim at the water holes in sequence. Thus, water fed to each nozzle can spurt out to form various water screens when the rotary shaft (72) is rotated.

According to the above description, the drawback of the electrically controlled fountain is that the inner structure is complex, and therefore both production and installation of the electrically controlled fountain are troublesome for the manufacturer and users.

To overcome the shortcoming, the present invention tends to provide a fountain device with a rotating screen that has a simple structure, yet has a lot of variations in appearance.

### SUMMARY OF THE INVENTION

The main objective of the invention is to provide a fountain device with a rotating revolver that has a lot of variations in appearance by the changing of a top revolver.

Another objective of the invention is to provide a fountain device with a rotating revolver that has simple structure and is easy to be produced or repaired.

Still another objective of the invention is to provide a fountain device with a rotating revolver wherein the revolver is driven by hydraulic power.

Other objects, advantages and novel features of the invention will become more apparent from the following detailed description when taken in conjunction with the accompanying drawings.

### BRIEF DESCRIPTION OF THE DRAWINGS

FIG. 1 a cross-sectional side view of a fountain device with a rotating revolver wherein the revolver is pyramid-shaped;

FIG. 2 is a cross-sectional side view of a first embodiment of the fountain device with a rotating revolver wherein the revolver is cubic-shaped;

FIG. 3 is a cross-sectional side view of a second embodiment of the fountain device with a rotating revolver wherein the revolver is diamond-shaped;

FIG. 4 is a cross-sectional side view of a third embodiment of the fountain device with a rotating revolver wherein the revolver is ball-shaped;

FIG. 5 is a perspective view of an electrically controlled fountain; and

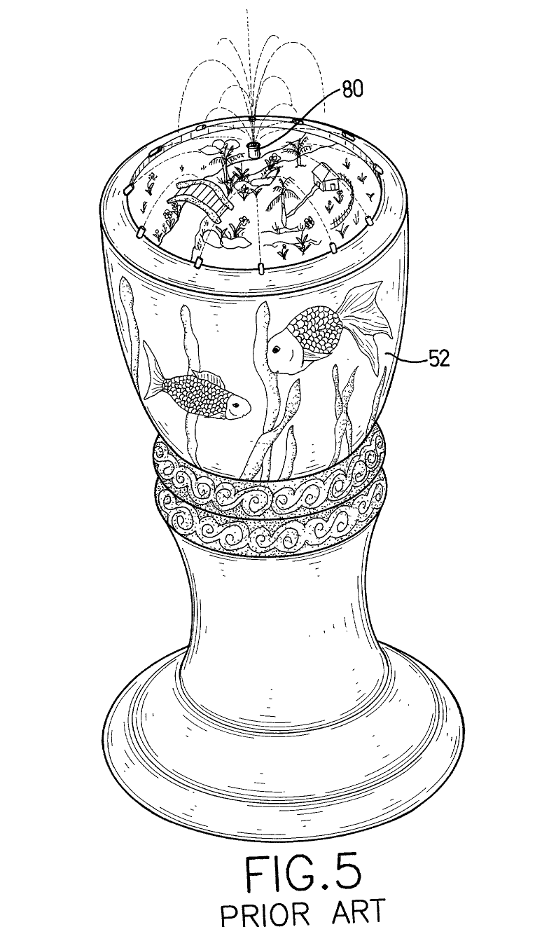

FIG. 6 is a perspective view of an inner structure of the electrically controlled fountain in accordance with FIG. 5.

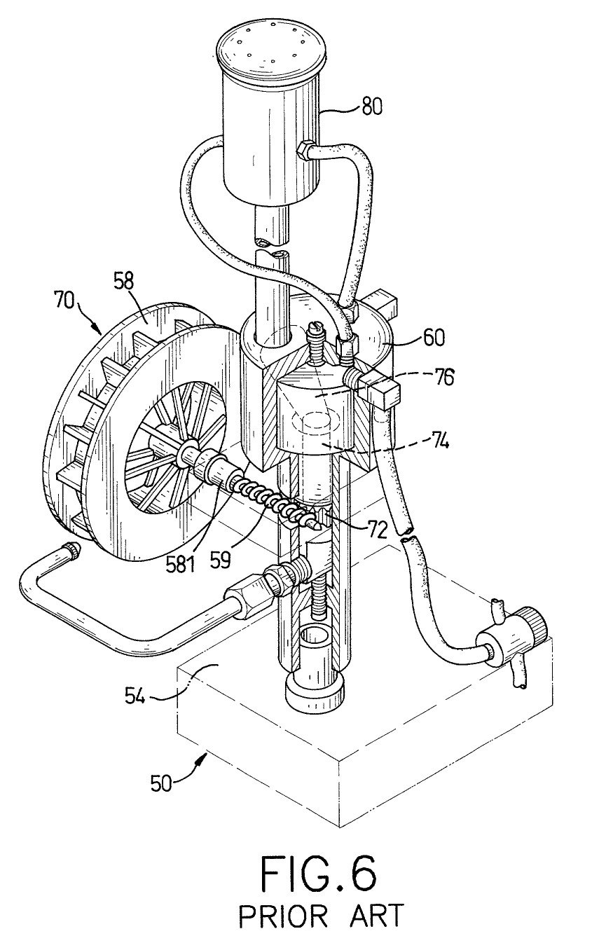

### DETAILED DESCRIPTION OF PREFERRED EMBODIMENT

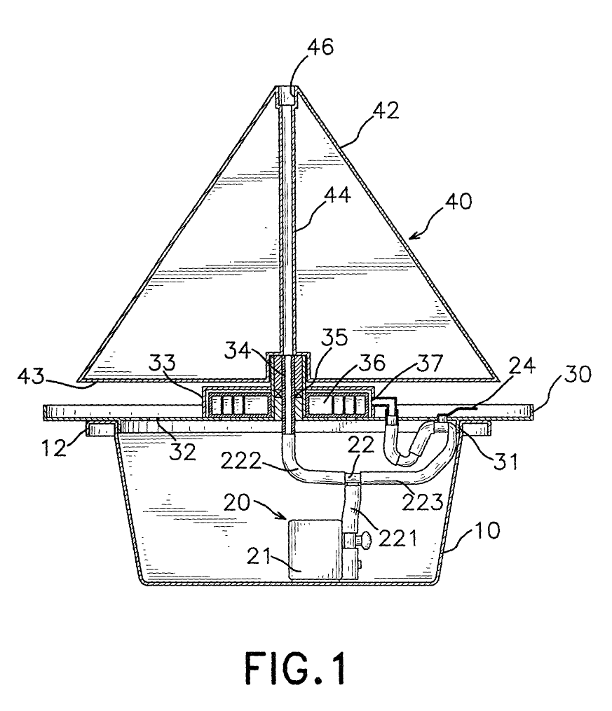

With reference to FIG. 1, a fountain device with a rotating revolver consists of a reservoir (10), a water supply system (20), a cover (30) with a bearing system, and a revolver (40).

The reservoir (10) is a basin functioning as a base of the fountain device with the rotating screen, and has a flat rim (12) formed around a top edge of the reservoir (10).

The water supply system (20) is composed of a water pump (21) and a two-way pipe (22). The water pump (21) is connected with a master pipe (221) of the two-way pipe (22). A first way (223) of the two-way pipe (22) has an adjusting valve (24) installed on the cover (30).

The cover (30) is a shallow plate that has a larger size than the reservoir (10), a downward fixing ring (31) formed at a bottom face of the cover (30), and multiple drain holes (32) defined in the bottom face and in the range of the fixing ring (31). The fixing ring (31) wedges inside the reservoir (10) when the cover (30) closes the reservoir (10). A blade chamber (33) is formed on the cover (30), and has the bearing system comprising an axle tube (34) and a bearing (35). The axle tube (34) penetrates a center of the cover (30) and communicating with a first way (222) of the two-way pipe (22). A nozzle (37) is secured on a side-wall of the blade chamber (33) and connected with the second way (223) of the two-way pipe (22). Inside the blade chamber (33), the bearing (35) is pivotally mounted on the axle tube (34) and has a plurality of radial blades (36) attached therearound.

The revolver (40) is a pyramid pivotally mounted on the bearing system of the cover (30) and is a hollow body composed of a shell (42) and a bottom board (43). A tube (44) is vertically secured in the middle of the revolver (40) and communicated with outside via a spurt opening (46) defined at an apex of the revolver (40). The tube (44) is also communicated with the axle tube (34) of the bearing system.

In operation of the fountain device, water stored in the reservoir (10) is pumped up along the master pipe (221) and divided into two streams by the two-way pipe (22) to the first way (222) and the second way (223). Then the water in the first way (222) is pumped up along the axle tube (34) to the tube (44) of the revolver (40) and spread out from the spurt opening (46) of the revolver (40). Spurted water slides downwardly along an exterior of the shell (42) of the revolver (40) and falls into the shallow plate of the cover (30), and then the water is filtered and returned to the reservoir (10) via the multiple drain holes (32) defined in the bottom of the cover (30). A quantity of water traveling along the first way (223) is controlled by the adjusting valve (24) and spurted out via the nozzle (37) to the blade (36) in the blade chamber (33). The hydraulic power of spurting water pushes the blades (36) to rotate the bearing (35), so that the revolver (40) rotates simultaneously with the bearing (35). Additionally, the adjusting valve (24) is used to control a rotating speed of the revolver (40).

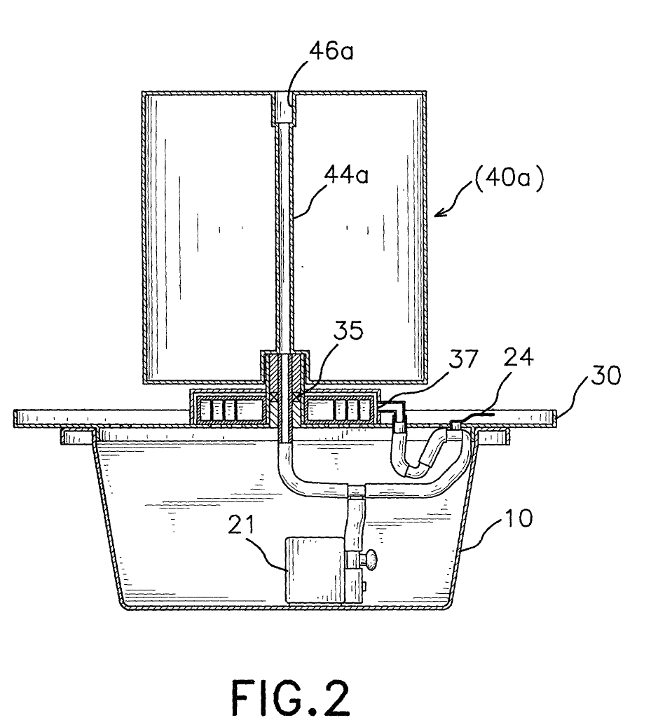

FIG. 2 is another preferred embodiment wherein the top revolver (40a) is hollow cube which is rotated by the hydraulic power of one stream of spurting water from the nozzle (37). Furthermore, this embodiment has the same reservoir (10), water supply system, and other elements in accordance with FIG. 1, and has another stream of water came from the tube (44a) to fall from the spurting opening (46a) at the apex of the revolver (40a).

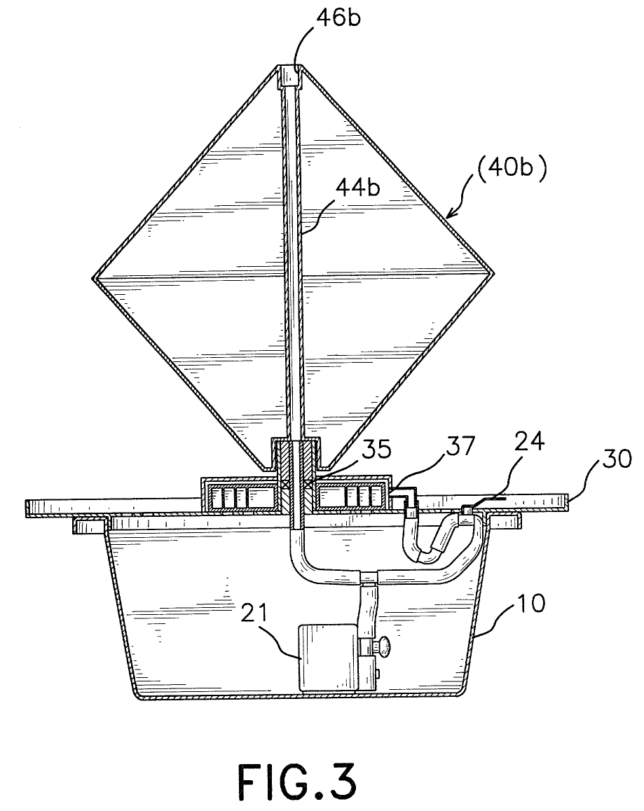

FIG. 3 is another preferred embodiment of this fountain device wherein the revolver (40b) is diamond-shaped hollow body and rotated by the hydraulic power of one stream of spurting water from the nozzle (37). Furthermore, this embodiment has the same reservoir (10), water supply system, and other elements in accordance with FIGS. 1 and 2, and has another stream of water came from the tube (44b) to fall from the spurting opening (46b) at the apex of the revolver (40b).

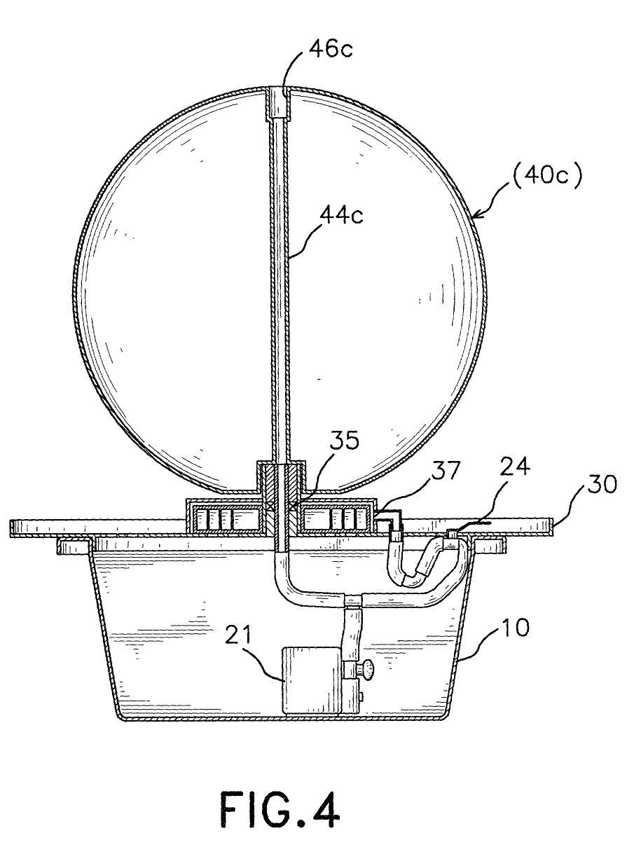

FIG. 4 is still another preferred embodiment of this fountain device wherein the revolver (40c) is ball-shaped and rotated by the hydraulic power of one stream of spurting water from the nozzle (37). Furthermore, this embodiment has the same reservoir (10), water supply system, and other elements in accordance with FIGS. 1, 2, and 3, and still has another stream of water came from the tube (44c) to fall from the spurting opening (46c) at the apex of the revolver (40c).

According to above description, it is to be understood that characters of the present invention combined with details of the structure are illustrative only and changes may be made in detail in matters of shape, size, and arrangement of parts within the principles of the invention to the full extent indicated by the broad general meaning of the terms in which the appended claims are expressed.

What is claimed is:

1. A fountain device with a rotating revolver comprising:
a reservoir;
a water supply system secured in the reservoir, and comprising a water pump, at least an adjusting valve, and a two-way pipe, the water pump being connected with the two-way pipe, and the at least one adjusting valve installed on the two-way pipe to control a quantity of water pumped from the reservoir;
a cover mounted on the reservoir and having multiple drain holes defined in a bottom face of the cover, a blade chamber formed on the cover and secured a bearing inside the blade chamber, and a nozzle formed inside the blade chamber and communicated the water supply system, said bearing inside the blade chamber having an axle tube and a plurality of radial blades formed around the axle tube; and
a top revolver mounted on the cover and connected with the axle tube to rotate with the radial blades.

2. The fountain device with a rotating revolver as claimed in claim 1, wherein the cover having a fixing ring downwardly formed at the bottom face of the cover and the fixing ring wedges inside the reservoir to position the cover on the reservoir.

3. The fountain device with a rotating revolver as claimed in claim 2, wherein an adjusting valve is installed to control the quantity of water to rotate the radial blades inside the blade chamber

4. The fountain device with a rotating revolver as claimed in claim 2, wherein the top revolver is pyramid-shaped.

5. The fountain device with a rotating revolver as claimed in claim 3, wherein the top revolver is pyramid-shaped.

6. The fountain device with a rotating revolver as claimed in claim 2, wherein the top revolver is cubic.

7. The fountain device with a rotating revolver as claimed in claim 3, wherein the top revolver is cubic.

8. The fountain device with a rotating revolver as claimed in claim 2, wherein the top revolver is diamond-shaped.

9. The fountain device with a rotating revolver as claimed in claim 3, wherein the top revolver is diamond-shaped.

10. The fountain device with a rotating revolver as claimed in claim 2, wherein the top revolver is spherical.

11. The fountain device with a rotating revolver as claimed in claim 3, wherein the top revolver is spherical.
